(19) United States
(12) Patent Application Publication
(10) Pub. No.: US 2008/0172920 A1
(43) Pub. Date: Jul. 24, 2008

(54) Device and coupling for producing erratic motion in a decoy

(76) Inventors: George W. Brint, Bolivar, TN (US); Paul H. Comerford, Murrieta, CA (US)

Correspondence Address: John M. Harrison, 2139 E. Bert Kouns, Shreveport, LA, 71105, US

(21) Appl. No.: 11/732,292

(22) Filed: Mar. 10, 2008

Related U.S. Application Data
(62) Division of application No. 11/112,521, filed on Apr. 25, 2005, now abandoned.
(60) Provisional application No. 60/639,929, filed on Dec. 30, 2004.

(51) Int. Cl. A01M 31/06

(52) U.S. Cl. 43/2

(57) ABSTRACT

A device and coupling for producing erratic, random motion in decoys to attract wildlife, which device includes an erratic motion-generating device characterized by an electric motor that causes a flexible arm extending from the motor to move in an erratic, random motion and facilitate lifelike movement of a decoy body mounted on the flexible arm by means of a typically tubular coupling. Various decoy bodies or “shells”, including goose, turkey and duck decoy shells, are adapted for mounting on hollow tubes and inserts of various length fitted on the flexible arm to facilitate the desired erratic and random motion of the decoy shells. The erratic motion device can be constructed and programmed to produce a wide variety of erratic, random and unpredictable movement in the removable decoy shells for attracting the wildlife. A method of producing erratic motion in decoys which includes the steps of mounting the decoys on a tubular coupling attached to a flexible arm extending from an erratic motion-producing device and operating the device to generate erratic, random and unpredictable motion in the flexible arm, the tubular coupling and the decoys.

### CROSS-REFERENCE TO RELATED APPLICATIONS

This application claims the benefit of and incorporates by reference prior filed, U.S. Provisional Application Ser. No. 60/639,929, Filed Dec. 30, 2004.

### SUMMARY OF THE INVENTION

A new and improved device and coupling for producing erratic, random motion in various decoys to attract wildlife for observation, photography and/or hunting purposes, and a method for accomplishing this erratic and random motion in the decoys. The device includes an electric motor typically mounted in a housing and normally operated by batteries, with a flexible arm extending from the electric motor, such that the electric motor can be alternately operated in two rotational directions at various speeds and intervals to impart an erratic, random and unpredictable movement to the flexible arm. A decoy body or “shell” such as duck, goose, turkey or a turkey tail and like decoy, in non-exclusive particular, is fitted on a typically hollow tube of selected length, or on an insert provided on the tube, which tube coupling is in turn, fitted over the flexible arm to impart the desired erratic motion produced by the motor to the decoy, for the attraction of wildlife. In a preferred embodiment of the invention the tube fitted over the flexible arm includes a crimp intermediate the tube ends, which crimp engages an enlargement at the tip of the flexible arm to limit the extension of the tube onto the arm. Furthermore, the upper end of the hollow tube may be fitted with a grooved or smooth rod insert, typically having a grommet fitted over the end thereof for limiting the depth of extension of the rod insert into the decoy shell or body when the decoy is mounted on the decoy insert.

### BRIEF DESCRIPTION OF THE DRAWINGS

The invention will be better understood by reference to the accompanying drawings, wherein:

FIG. 1 is a perspective view of a typical device for producing an erratic motion in decoys;

FIG. 2 is a perspective view of a pair of support or coupling tubes of dissimilar length for insertion over the upward-standing flexible arm of the device illustrated in FIG. 1;

FIG. 3 is a perspective view of a pair of tube inserts for insertion in the top ends of the support tubes illustrated in FIG. 2 and receiving the decoy bodies or shells;

FIG. 3A is a front elevation of the device for producing erratic motion illustrated in FIG. 1;

FIG. 4 is a sectional view taken along line 4-4 of the device illustrated in FIG. 1;

FIG. 5 is a perspective view of an alternative device for producing erratic motion in decoys;

FIG. 6 is a perspective view of the device for producing erratic motion in decoys illustrated in FIGS. 1, 3A and 4 and a duck decoy body or shell mounted on a support tube coupling and insert for imparting erratic motion in the duck decoy responsive to operation of the device;

FIG. 7 is a perspective view of the device illustrated in FIGS. 1, 3A and 4 and a goose decoy body or shell mounted on a support tube coupling and insert for imparting erratic motion in the goose decoy responsive to operation of the device; and

FIG. 8 is a perspective view of the device illustrated in FIGS. 1, 3A and 4 and a turkey decoy body or shell mounted on a support tube coupling for imparting erratic motion in the turkey decoy responsive to operation of the device.

### DESCRIPTION OF THE PREFERRED EMBODIMENTS

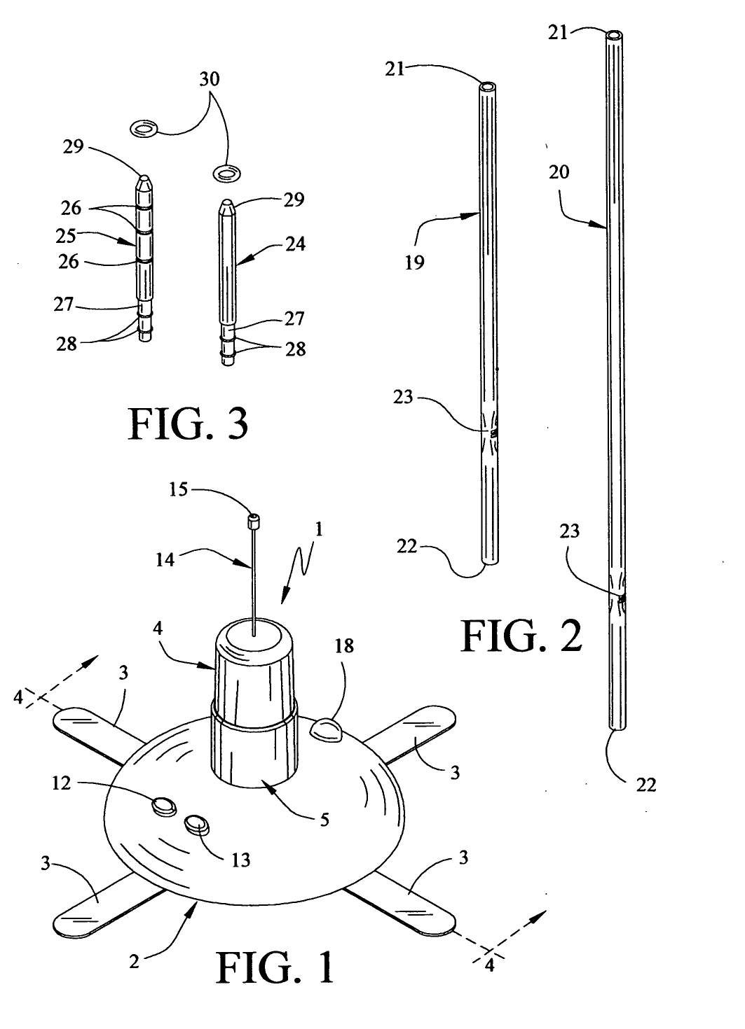

Referring initially to FIGS. 1, 3A and 4 of the drawings in a first preferred embodiment a first erratic motion device of this invention is illustrated by reference numeral 1. The first erratic motion device 1 is disclosed in pending application Ser. No. 10/801,873, filed Mar. 16, 2004, and is characterized by a rounded base 2 which is closed at the bottom by a base plate 6, typically fitted with three, spaced-apart base plate feet 6a, for supporting the base 2 on a surface (FIG. 4). A base interior 2a contains a control circuit 7 having control circuit wiring 8 and includes a battery housing 9 containing multiple batteries 10, as further illustrated in FIG. 4. A hollow, cylindrical housing mount 5 extends upwardly from the base 2 and terminates in a motor housing 4 having a motor housing interior 4a that accommodates an electric motor 16, fitted with electric motor wiring 17, as illustrated in FIG. 4 of the drawings. A housing mount interior 5a inside the housing mount 5 accommodates the electric motor wiring 17 and the connecting control circuit wiring 8, which are connected in such a manner as to facilitate operation of the electric motor 16 by operation of control circuit 7, as detailed in application Ser. No. 10/801,873, filed Mar. 16, 2004, and as hereinafter further described.

As further illustrated in FIGS. 1, 3A and 4 of the drawings four outrigger stabilizers 3 are each typically pivotally attached to the base plate 6 at spaced-apart intervals by means of a corresponding spring-loaded outrigger mount 11, such that each outrigger stabilizer 3 can be folded inwardly of the base 2 and the base plate 6 for packaging and storing, and outwardly thereof, as illustrated in FIG. 1, to stabilize the base 2 during operation of the erratic motion device 1 further hereinafter described. An activator switch 12 is also provided on the base 2, along with a timer switch 13, which activator switch 12 and timer switch 13 are wired into the control circuit 7 by wiring (not illustrated), according to the disclosure in application Ser. No. 10/801,873, filed Mar. 16, 2004, and the knowledge of those skilled in the art. A flexible arm 14 of selected material, length and resiliency extends through the top of the motor housing 4 and serves as a flexible shaft of the electric motor 16 to facilitate rotation, counter-rotation and bending of the flexible arm 14 responsive to operation of the electric motor 16. An enlarged end portion 15 is provided, typically on the extending end of the flexible arm 14, for purposes which will be further hereinafter described. A speed control switch 18 is also provided on the base 2 (FIG. 1) and the speed control switch 18 is wired into the control circuit 7 illustrated in FIG. 4, further according to the disclosure in application Ser. No. 10/801,873, filed Mar. 16, 2004, to vary the rotational speed and thus, the flexure of the flexible arm 14 during operation of the electric motor 16.

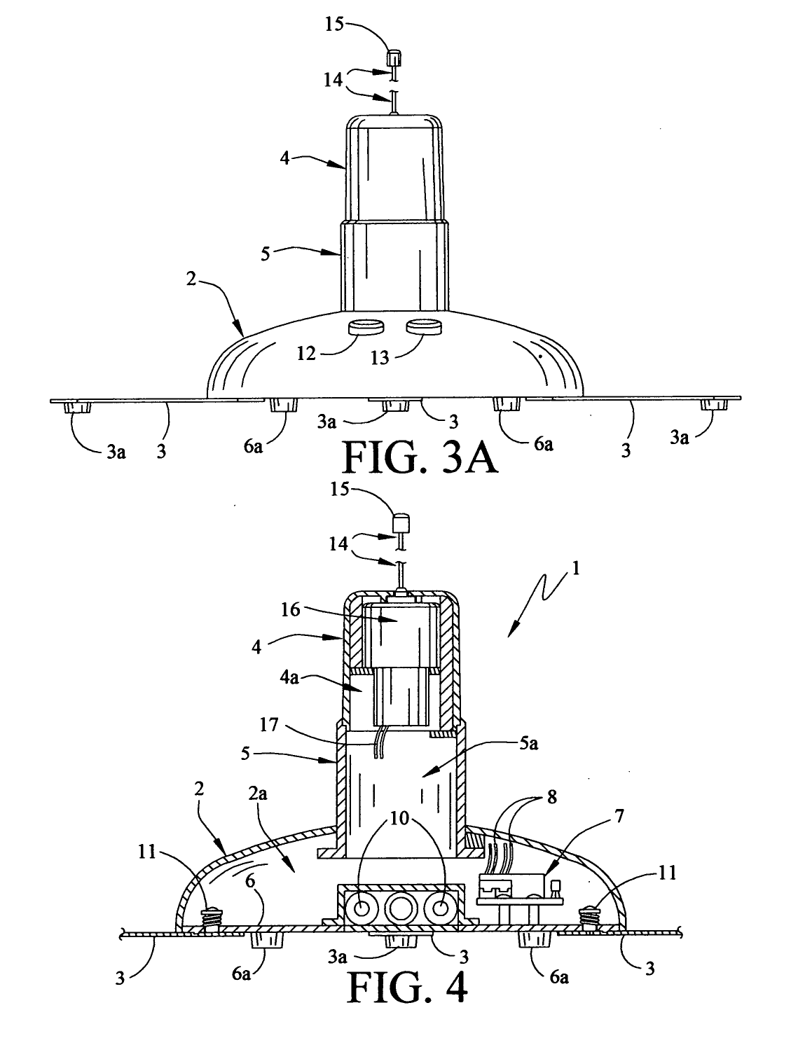

Referring now to FIGS. 2 and 3 of the drawings a short support tube 19 and a long support tube 20 of similar design are illustrated, each of the short support tube 19 and long support tube 20 having a top tube end 21, a bottom tube end 22 and a tube crimp 23 intermediate the top tube end 21 and the bottom tube end 22. As illustrated in FIG. 3 a smooth tube insert 24 and a grooved tube insert 25 are illustrated, each having a tube insert nipple 27 on the bottom end thereof, fitted with at least one and preferably two, concentric nipple collars 28 that project radially outwardly from the round surface of the tube insert nipple 27, to facilitate secure, yet removable insertion of the tube insert nipple 27 of each of the smooth tube insert 24 and the grooved tube insert 25 into the top tube end 21 of the short support tube 19 and the long support tube 20, respectively. Rubber or plastic tube insert grommets 30 typically fit over the decoy engaging ends 29 of each of the smooth tube insert 24 and the grooved tube insert 25 to facilitate resting of the respective decoy bodies or shells on the smooth tube insert 24 and grooved tube insert 25 at a selected depth, respectively, as further hereinafter described. As further illustrated in FIG. 3 the smooth tube insert 24 is characterized by a smooth, cylindrical surface area extending from the decoy engaging end 29 to the tube insert nipple 27, while multiple tube insert grooves 26 are provided in spaced-apart relationship on the corresponding surface of the grooved tube insert 25, for more security in seating and locating the tube insert grommets 30, as illustrated.

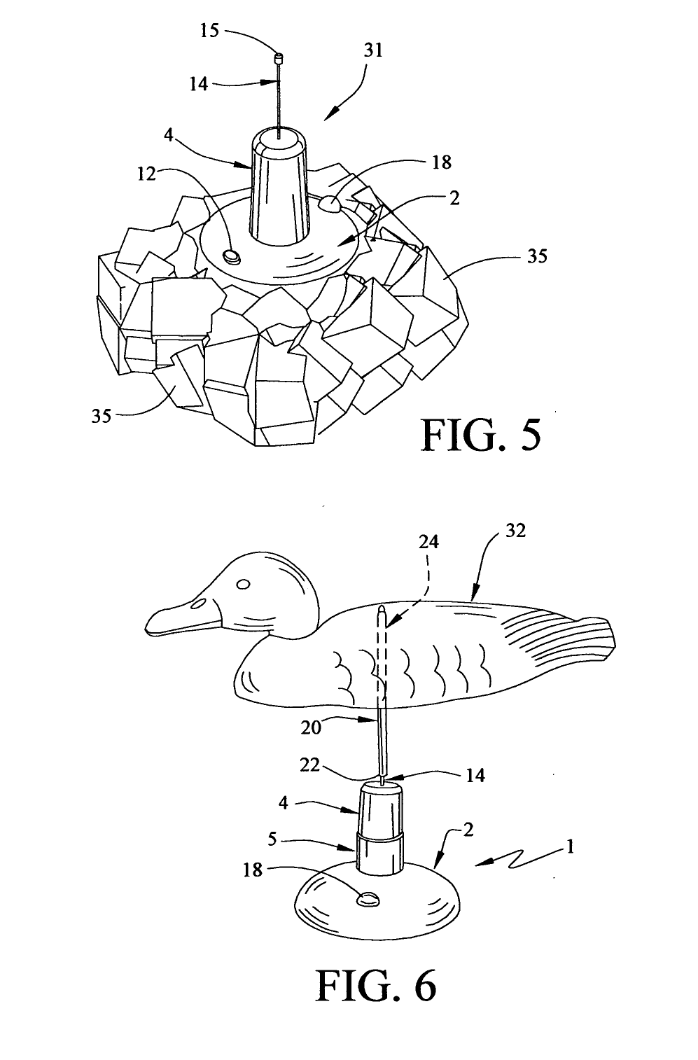

Referring now to FIG. 5 of the drawings in another preferred embodiment of the invention an alternative erratic motion device 31 is illustrated and includes a housing 2 fitted with an upward-standing motor housing 4 that encloses an electric motor 16, typically in the manner illustrated in FIG. 4 of the drawings with respect to the first erratic motion device 1. A speed control switch 18 is provided for electrical cooperation with a suitable control circuit such as the control circuit 7 illustrated in FIG. 4, to facilitate rotation and counter-rotation of the upward-standing flexible arm 14 and end portion 15 in desired directions and at desired speeds and rotational intervals for a selected time, according to the design of the alternative erratic motion device 31. The alternative erratic motion device 31 can be stabilized in place by multiple rocks 35 or it may be placed in a hole or dip in the terrain to prevent overturning during operation.

Referring to FIGS. 2 and 6 of the drawings, under circumstances where either the first erratic motion device 1 illustrated in FIGS. 1, 3A and 4 or the alternative erratic motion device 31 illustrated in FIG. 5 is utilized, a duck decoy body or shell 32 is typically inserted on a smooth tube insert 24, fitted in the top tube end 21 of a long support tube 20 which is inserted over the flexible arm 14. The long support tube 20 fits over the flexible arm 14 such that the enlarged end portion 15 engages the tube crimp 23 (FIG. 2) in the long support tube 20, thus limiting further travel of the long support tube 20 downwardly on the flexible arm 14. This design feature facilitates bending and flexure of the flexible arm 14, primarily at a point between the bottom tube end 22 of the long support tube 20 and the top face of the motor housing 4 from which the flexible arm 14 projects, to allow a selected erratic, random and accentuated movement of the duck decoy shell 32 and long support tube 20 with respect to the erratic motion device 1, due to the flexure of the flexible arm 14.

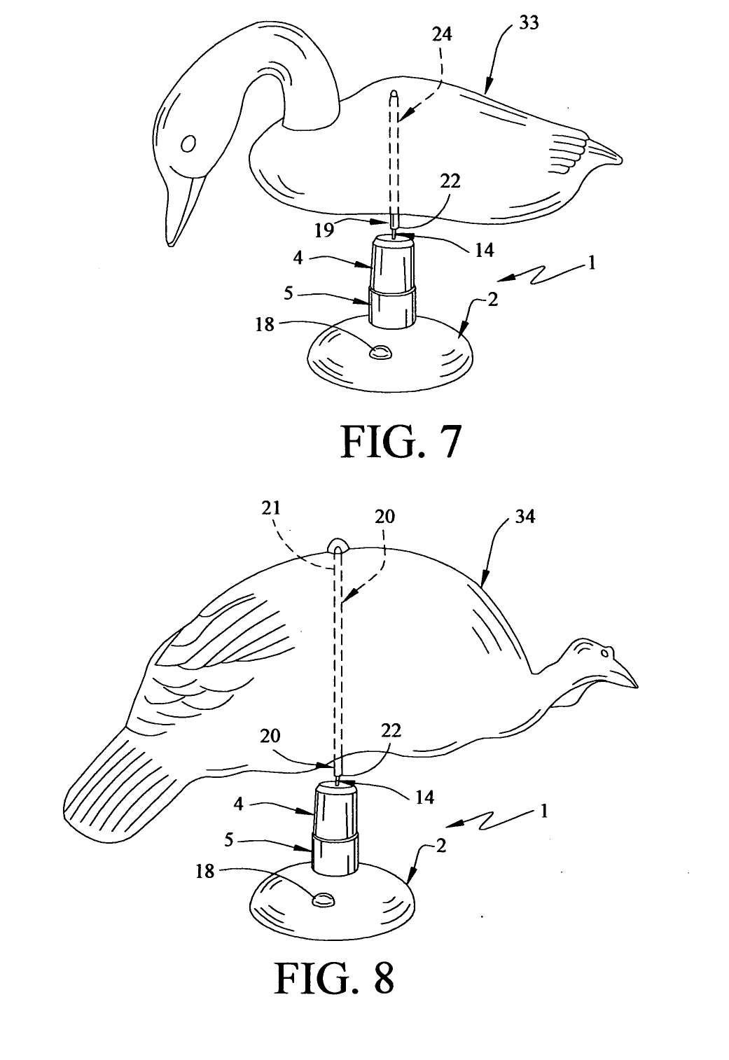

As further illustrated in FIG. 7 of the drawings a goose decoy shell 33 is typically fitted to the smooth tube insert 24 seated in the top tube end 21 of a short support tube 19, which is fitted over the flexible arm 14 in the same manner as the long support tube 20 illustrated in FIG. 6. Accordingly, the flexible arm 14 is able to bend and flex and facilitate an erratic, random and accentuated movement of the goose decoy shell 33 and short support tube 19 responsive to operation of the first erratic motion device 1.

Referring now to FIG. 8 of the drawings, in similar manner a turkey decoy shell 34 is seated on the top end 21 of a long support tube 20 without use of either a smooth tube insert 24 or a grooved tube insert 25. As in the case of the duck decoy shell 32 and the goose decoy shell 33 illustrated in FIGS. 6 and 7 of the drawings, a length of the flexible arm 14 is exposed between the bottom tube end 22 of the long support tube 20 and the top of the motor housing 4 to facilitate erratic, random and accentuated movement of the turkey decoy shell 34 responsive to operation of the electric motor 16 and flexure of the flexible arm 14 in the first erratic motion device 1, as hereinafter further described.

In detailed operation, the first erratic motion device 1 and alternative erratic motion device 31 are operated to impart a desired erratic, random and accentuated movement of each of the duck decoy shell 32, the goose decoy shell 33 and the turkey decoy shell 34 for selected periods of time and rotational intervals, responsive to operation of the respective electric motor 16, as follows. With respect to the first erratic motion device 1 illustrated in FIGS. 1, 3A, 4 and 6-8 of the drawings, the respective duck decoy shell 32, goose decoy shell 33 and turkey decoy shell 34 are arranged as illustrated in FIGS. 6-8 on the corresponding smooth tube insert 24, short support tube 19 and long support tube 20, respectively. Each of the short support tube 19 and long support tube 20 is fitted over the corresponding flexible arm 14 extending from the top end of the motor housing 4 in position for motion responsive to activation of the electric motor 16. Activation of the electric motor 16 and orchestration of arm motion by the control circuit 7 is accomplished by pressing the pressure-activated activator switch 12 and timer switch 13 on the base 2 of the first erratic motion device 1 to effect rotation and counter-rotation of the flexible arm 14 in selected directions for pre-programmed periods of time and rotational intervals determined by the design of the control circuit 7. Furthermore, manual operation of the speed of the electric motor 16 and movement of the flexible arm 14 can be effected by manipulation of the speed control switch 18, which effects a desired degree of erratic and random motion in the corresponding duck decoy shell 32, goose decoy shell 33 and turkey decoy shell 34. Specific design and operation of the first erratic motion device 1 is detailed in U.S. patent application Ser. No. 10/801,873, Filed Mar. 16, 2004. In like manner, the alternative erratic motion device 31 illustrated in FIG. 5 of the drawings is energized by an on/off switch 12 and manipulation of the corresponding speed control switch 18 is effected to create the desired erratic, random rotation and counter-rotation motion in the duck decoy shell 32, the goose decoy shell 33 and the turkey decoy shell 34.

It will be recognized and understood by those skilled in the art that any type of erratic motion device can be used which will utilize a flexible arm 14 of suitable size, material and resiliency to impart an erratic, random and unpredictable motion of desired magnitude, degree, speed and rotational interval in a duck decoy shell 32, goose decoy shell 33 and turkey decoy shell 34. It will be further appreciated that various other bird and animal decoys can be applied to the flexible arm of an erratic motion device of choice using a hollow tube or a solid tube with a bottom opening for receiving the flexible arm, to attract wildlife of various character.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A device and coupling for producing erratic motion in a decoy, comprising an erratic: motion device having a motor and a flexible arm connected to said motor, said flexible arm capable of rotation and counter-rotation at selected speed and a tubular coupler for engaging the flexible arm and the decoy, wherein said tubular coupler and the decoy are caused to exhibit said erratic motion responsive to operation of said motor and said rotation and counter-rotation of said flexible arm.

2. The device and coupling of claim 1 comprising an enlargement provided on said flexible arm and a crimp provided in said tubular coupler for engaging said enlargement when said tubular coupler is inserted on said flexible arm.

3. The device and coupling of claim 1 comprising an insert provided in one end of said tubular coupler for engaging the decoy.

4. The device and coupling of claim 1 comprising:
(a) an enlargement provided on said flexible arm and a crimp provided in said tubular coupler for engaging said enlargement when said tubular coupler is inserted on said flexible arm; and
(b) an insert provided in one end of said tubular coupler for engaging the decoy.

5. The device and coupling of claim 1 comprising at least one stabilizer provided on said device for stabilizing said device on a supporting surface responsive to said operation of said motor and said rotation and counter-rotation of said flexible arm.

6. The device and coupling of claim 5 comprising an enlargement provided on said flexible arm and a crimp provided in said tubular coupler for engaging said enlargement when said tubular coupler is inserted on said flexible arm.

7. The device and coupling of claim 5 comprising an insert provided in one end of said tubular coupler for engaging the decoy.

8. The device of claim 5 comprising:
(a) an enlargement provided on said flexible arm and a crimp provided in said tubular coupler for engaging said enlargement when said tubular coupler is inserted on said flexible arm; and
(b) an insert provided in one end of said tubular coupler for engaging the decoy.

9. The device and coupling of claim 1 comprising an activation switch and a speed control switch provided in electrical connection with said motor for activating said motor and controlling the speed of said rotation and counter-rotation of said flexible arm.

10. The device and coupling of claim 9 comprising an enlargement provided on said flexible arm and a crimp provided in said tubular coupler for engaging said enlargement when said tubular coupler is inserted on said flexible arm.

11. The device and coupling of claim 9 comprising an insert provided in one end of said tubular coupler for engaging the decoy.

12. The device and coupling of claim 9 comprising
(a) an enlargement provided on said flexible arm and a crimp provided in said tubular coupler for engaging said enlargement when said tubular coupler is inserted on said flexible arm; and
(b) an insert provided in one end of said tubular coupler for engaging the decoy.

13. A device and coupling for producing erratic, random motion in a decoy, comprising an erratic motion device having an electric motor and a flexible arm extending from said motor, said flexible arm capable of rotation and counter-rotation at selected intervals and speed; a tubular coupler fitted on the flexible arm; and an insert provided in said tubular coupler for engaging the decoy, wherein said tubular coupler, said insert and the decoy are caused to exhibit said erratic, random motion responsive to operation of said electric motor and said rotation and counter-rotation of said flexible arm at said selected intervals and speed.

14. The device and coupling of claim 13 comprising an enlargement provided on said flexible arm and a crimp provided in said tubular coupler for engaging said enlargement when said tubular coupler is inserted on said flexible arm.

15. The device and coupling of claim 13 comprising a set of stabilizers spaced-apart on said device for stabilizing said device on a supporting surface responsive to said rotation and counter-rotation of said flexible arm.

16. The device and coupling of claim 13 comprising:
(a) an enlargement provided on said flexible arm and a crimp provided in said tubular coupler for engaging said enlargement when said tubular coupler is inserted on said flexible arm; and
(b) a set of stabilizers spaced-apart on said device for stabilizing said device on a supporting surface responsive to said rotation and counter-rotation of said flexible arm.

17. The device and coupling of claim 13 comprising an activation switch, a speed control switch, a timer switch and an electronic circuit provided in electrical connection with said motor for activating said motor and controlling the speed, time and interval of said rotation and counter-rotation of said flexible arm.

18. The device and coupling of claim 17 comprising an enlargement provided on said flexible arm and a crimp provided in said tubular coupler for engaging said enlargement when said tubular coupler is inserted on said flexible arm.

19. The device and coupling of claim 18 comprising a set of stabilizers spaced-apart on said device for stabilizing said device on a supporting surface responsive to said rotation and counter-rotation of said flexible arm.

20. A method for inducing erratic, random motion in a decoy, comprising the steps of providing an erratic motion-generating device having a motor and a flexible arm extending from the motor; placing a tubular coupler on the flexible arm; mounting the decoy on the tubular coupler; and activating the motor to induce the erratic, random motion in the tubular coupler and the decoy.

21. The method of claim 20 comprising the step of applying an insert to the tubular coupler and mounting the decoy on the insert.

22. The method of claim 20 comprising the step of providing a speed control switch on the device electrically connected to the motor to control the speed of rotation and counter-rotation of the flexible arm, the tubular coupler and the decoy.

23. The method of claim 20 comprising the step of providing a timer control switch and an electronic circuit in the device electrically connected to the motor, to control the time and interval of rotation and counter-rotation of the flexible arm, the tubular coupler and the decoy.

24. The method according to claim 20 comprising the step of providing a motor activation switch on the device electrically connected to the motor to control activation of the motor.

25. The method according to claim 20 comprising the steps of:
(a) providing a speed control switch on the device electrically connected to the motor, to control the time and interval of rotation and counter-rotation of the flexible arm, the tubular coupler and the decoy; and
(b) providing a timer control switch and an electronic circuit in the device connected to the motor, to control the time and interval of rotation and counter-rotation of the flexible arm, the tubular coupler and the decoy; and
(c) providing a motor activation switch on the device electrically connected to the motor to control activation of the motor.

26. The method according to claim 25 comprising the step of applying an insert to the tubular coupler and mounting the decoy on the insert.
